(19) United States
(12) Patent Application Publication
(10) Pub. No.: US 2004/0001095 A1
(43) Pub. Date: Jan. 1, 2004

(54) Method and apparatus for universal device management

(76) Inventor: Todd Marques, Pleasanton, CA (US)

Correspondence Address: Everitt G. Beers, McNichols Randick O'Dea & Tooliatos, LLP, Ste. 400, 5000 Hopyard Road, Pleasanton, CA, 94588, US

(21) Appl. No.: 10/188,258

(22) Filed: Jul. 1, 2002

(51) Int. Cl. G09G 5/00

(52) U.S. Cl. 345/771

(57) ABSTRACT

A method and apparatus for universal device management using in its preferred embodiment, a software-based process that enables devices such as PDA's and mobile phones to discover, monitor, and control electronic devices in diverse applications such home entertainment, mobile computing, automotive systems, data networking, and household and office automation. The system comprises a user interface residing typically on a handheld device, a lightweight embedded agent that runs on all managed devices, and a wireless communication infrastructure that allows wireless communication between the interface and all devices, regardless of device type or manufacturer. The user interface provides users with a common look-and-feel for managing all devices.

### BACKGROUND OF THE INVENTION

A. Field Of The Invention

The present invention relates to a universal device management system (“UDMS”). This invention provides its users with one clear and consistent user interface (“UI”) for managing configurable devices of all sorts via remote control (“RC”). The UI consists of the controls and displays presented to the user that allow a device to be manipulated. RC is the principal mechanism by which a user controls a device or system of devices from a distance. Applications of UDMS include household appliances, home automation, consumer electronics, networking appliances and equipment, and automotive systems, to name a few.

B. Description Of Related Art

Years ago, user interfaces were primarily mechanical in nature, consisting of arrays of buttons, switches, knobs, and dials. Today, the graphical user interfaces (“GUI”) has become increasingly common. GUI's are software-based and consist of a graphical display device listing data and options that can be selected via graphical point-and-click buttons, checkboxes, and choice menus, as well as various fields for the entry of textual data via a keyboard or a stylus. Whether a UI is mechanical, graphical, or some combination of the two, it is central to the control of many home and office devices and to the successful completion of everyday self-service activities, such as ticket purchases, ATM transactions, and information requests at a kiosk.

Most current UI's are designed only for a single and particular vendor-specific device. Some vendors have attempted to create a general UI across their own product line to control their own products. However, even where vendors have attempted to create such a general UI, the current implementations have significant disadvantages. Due to changing product lines, vendors change their UI's regularly, often with each version or model year. Thus common tasks, such as setting the time of day, must be re-learned for each vendor, for each model year, and for each device type. It is a difficult and time-consuming task to learn and re-learn the intricacies of all UI's with which a person may need to interact to control devices. Due to the multiplicity of UI's and their individual and differing intricacies, users often do not learn to use many of the features available.

Further, to the extent current remote controls control multiple devices, there is a need to manually and individually configure or program the remote control with the command codes related to each individual device.

Further, current remote controls are generally based on line-of-sight infrared technology for communicating with the devices being controlled. Such a communication method limits the ability to remotely control devices located out of the line-of-sight of the controller, such as in another room.

Therefore, there is a need for a method and apparatus that (1) provides a common user interface for controlling devices of multiple types from multiple vendors, (2) provides automatic configuration and programming of control functions, and (3) provides an ability to remotely control devices located out of line-of-sight.

### SUMMARY OF THE INVENTION

Accordingly, it is an object of the present invention to overcome the problems of the prior art by providing a method and apparatus for the control of a plurality of devices using a common user interface that is automatically configured and programmed and which communicates by using non-line-of-sight technology.

In one embodiment, the method of the invention comprises connecting one or more device servers to a display client, the display client requesting transmission from each of the device servers of device-specific data, the device servers transmitting the requested information to the display client, the display client receiving the device-specific data, the display client generating a device-independent user interface using the device-specific data, displaying the device-specific data on the display client using the generated device-independent user interface, accepting user input resulting from the user interacting with the user interface displayed on the display client, and controlling the device by sending the commands from the display client to the device that were selected by the user's interaction.

In another embodiment of the invention, the method comprises discovering one or more devices automatically by a display client when the client moves into the range of the device, establishing a connection session between the display client and the detected device, conveying information from the device to the display client regarding the state and capabilities of the device, generating by the display client of a device-independent user interface to display the device information, displaying the device-independent user interface on the display client, controlling the device by the user selecting an option from the device-independent user interface on the display client, sending a command to the device based on the user's selection from the device-independent user interface on the display client, and terminating the session when the display client moves out of the range of the device.

Universal device management (“UDM”) allows users to understand easily and completely exploit the capabilities of a wide variety of devices. Some of the devices to which UDM is applicable are identified in the table in FIG. 1. However, the list of actual possibilities is limitless; the table only shows examples.

Further, a UDM client can include self-programming capabilities that automatically discover devices within close proximity that are equipped with UDM agent or server software. Once a UDM client discovers a device it automatically learns about the device's capabilities and how to control it. Further, as indicated above, UDM presents the same basic UI for controlling all the devices it discovers. Setting the time of day, for instance, is done exactly the same way on all devices, and in addition, the time settings of all devices can be performed simultaneously.

Further, UDM clients and servers can connect using non-line-of-sight communication means, such as radio communications using Bluetooth protocols. In many cases UDM will be running on mobile devices such as PDA's and handsets. Hence the device management capabilities are completely mobile. UDM users can use the same UDM-enabled PDA or handset to manage household devices while at home, automotive systems while in the car en route to the commuter train, informational and ticketing kiosks while at the train station and on the train, and office machines while at work.

### BRIEF DESCRIPTION OF THE DRAWINGS

FIG. 1 is a table showing a sampling of devices that can be supported by UDM.

FIG. 2 is a conceptual schematic showing the UDM distributed architecture.

FIG. 3 is a conceptual schematic showing a sample wireless communications infrastructure.

FIG. 4 is a conceptual schematic showing the architecture of the UDM application layer.

FIG. 5 is a table listing sample generic schema.

FIG. 6 is a sample code listing of XML schema for generic objects for use in a UDM application.

FIG. 7 is a table listing sample device-specific schema for a television.

FIG. 8 is a sample code listing of a XML schema for a television.

FIG. 9 is a sample XML instance data file.

FIG. 10 is a sample audio control adjustment screen.

### DESCRIPTION OF THE INVENTION

The present invention provides a universal device management method and system that enables handheld devices such as PDA's and mobile phones to discover, monitor, and control electronic devices in diverse applications such as home entertainment, mobile computing, automotive systems, data networking, and household business automation. The system comprises a user interface that resides on a handheld device, a lightweight embedded agent that runs on all managed devices, and a wireless communication infrastructure that allows wireless communication between the user interface and the agents.

A. Preferred Embodiment

In its preferred embodiment, UDM has the following capabilities:

Automatic Discovery and Understanding of Devices,

Configuration Management,

Performance Management,

Fault Management,

Security Management,

Device-Independent User Interface, and

Non-Line-Of-Sight Communication.

1. Automatic Discovery and Understanding of Devices

UDM automatically discovers and understands all nearby devices (within a distance of about 10 meters in one embodiment). To be discovered and managed, a device (any device) need only be equipped with UDM agent software, which in turn relies on a wireless capability. Once a device is discovered, it can be selected and controlled via the device-independent UI.

UDM UI automatically determines what the discovered device does and how it can be configured. The UDM UI also ascertains and stores the range of legal values for all configuration parameters. For example, the UI could ascertain and store the number_of_rings_before_pickup parameter on a particular fax machine and check that it must be an integer in the range of 1 and 8. Similarly it could ascertain and store the water_temperature on a specific water heater and check that it must be set to a value no higher than 125° F.

2. Configuration Management

Configuration management capability allows the user to initialize all configurable parameters for a device as part of the device's initial setup. Users can also view and modify configured parameters after the initial setup—thereby changing the behavior of the device.

The list of configurable parameters is device- and vendor-dependent. A common example of a configurable parameter is time_of_day. Many household and office devices with an LCD display time of day as one of their functions, and many devices also use time as part of their operation in carrying out various other functions. An example of another possible configuration parameter is number_of_rings_before_pickup. This parameter may be relevant to just a few classes of devices, such as fax machines and answering machines. A list of configurable parameters is developed separately for each device as part of the discovery and understanding process described above. Configuration management allows the user to access and manipulate the device's parameters remotely.

Also as part of the discovery and understanding process, UDM software validates all user entries against vendor-supplied specifications. Invalid entries are rejected.

3. Performance Management

Performance management capability allows a UDM user to monitor devices on an ongoing basis to determine whether they are performing in accordance with configured parameters. For example, if the thermostat was set to 68 F in zone 2, the actual air temperature could be monitored in zone 2 to assure that the thermostat and its heating or cooling system are working correctly. As another example, if the value of water_temperature for a water heater was configured as 120 F, performance management could check on what is the actual value of the water_temperature?

UDM provides the software infrastructure for interrogating devices for performance values. The values monitored vary according to the vendor and device type, just as with the configuration parameters discussed above.

4. Fault Management

Fault management capability allows a UDM user to receive alarms whenever a device goes into or out of a fault state. A fault state exits when the observed performance level of a device deviates from its configured level, or when its current performance is outside its own design specifications. A fault state may also arise from environmental factors when a device is operating under conditions for which it was not designed. The detection of extremely high or low ambient temperature is an example of an environmental alarm.

Alarm notifications are received automatically—the user does not have to request the information. A separate notification is sent for each alarm condition, both at the time when the alarm condition is detected and at the time when the condition disappears or is acknowledged by the user.

In addition to sending alarms when faults occur, Fault Management allows users to perform vendor-defined diagnostic tests in order to determine the cause of a fault. Users may initiate diagnostic tests on a device and view the result from the UDM UI.

5. Security Management

Security management capability controls who can access a device and what sorts of operations may be performed. For example, a homeowner likely will not want the password associated with his or her home security system to be viewable and changeable by all who happen to be within 10 meters carrying a PDA or handset equipped with UDM UI. Accordingly, the security capability of UDM allows the homeowner to limit access to data to a prescribed list of PDA's, handsets, laptops, or other UDM-enabled UI's.

Current UDM security does not actually control who can access the information, but instead controls which UDM-equipped PDA's, handsets, laptops, or other UDM-enabled UI's can access device information. That is, it controls which physical devices can access the information. For simplicity, there is no specific notion of an individual in UDM. However, since the UDM-equipped devices are designed to be owned by and regularly in the possession of specific individuals, the effect is the same.

The operations that can be performed on a device may also be controlled through security management. Rather than entirely turning on or off access to a particular device or piece of information, some users may be given permission to read a piece of information without being able to modify it. Others may be able read and modify one particular piece of information, but not another.

6. Device-Independent User Interface

UDM management software contains logic for interpreting a domain specification and rendering an appropriate UI that allows users to interact with and control various devices. The UI rendered by the manager is modality-dependent but device-independent. Modality-dependent means that the UI may take somewhat different forms depending on whether the UDM UI is running on a basic handheld device of some sort, a sophisticated PDA running Palm OS or Windows CE; a PC running Windows 95, 98, NT, XP; or a workstation running Linux, Solaris, or some other variant of Unix.

The key point is that the UI does not differ according to the type of device being managed or the manufacturer of the device. Device-independence allows users to develop a comfort level with a particular mode of interaction that is applicable regardless of whether the device is a piece of data communications gear or a household appliance.

Various implementations of the UDM UI for handhelds include ones that comply with the UI guidelines for Palm OS and Windows CE.

7. Non-Line-Of-Sight Communication

UDM includes communication between the client and the servers using non-line-of-sight wireless communications. For example, one embodiment uses radio frequencies and Bluetooth wireless protocols.

B. Implementation

UDM is implemented as a distributed, client/server architecture. The client provides the administrative UI through which users monitor and control devices.

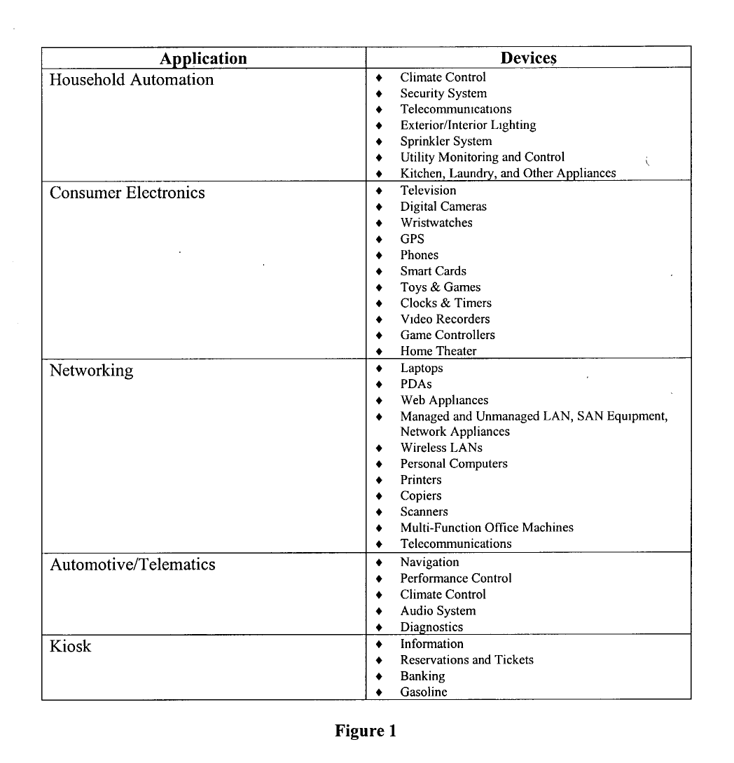

The server resides on various devices such as TV's and games, household appliances, data communications gear, and automotive systems (for further examples, see table in FIG. 1). It responds to requests from the UI. Since the server is a small, lightweight application that is embedded on the device and dedicated to management, it can also be referred to in standard network management parlance as an agent program.

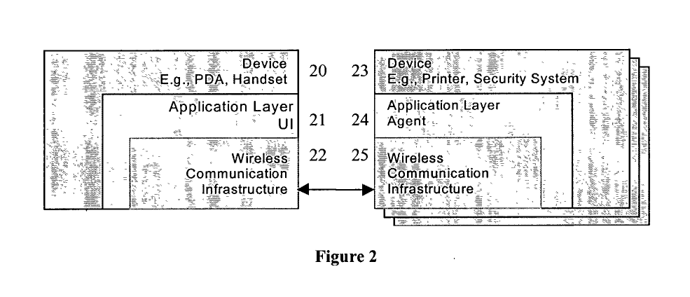

FIG. 2 provides a high-level view of the UDM distributed architecture. FIG. 2 depicts the UI and agent devices as having three layers. The topmost layers 20 and 23 relate to the native functionality of the device, be it the controlling UI or the controlled device. For example, for PDA's the device would be PIM-type functionality 20 and for printers it would be printing-related functionality 23. UDM is not specifically concerned with this layer of native functionality. However, the layers 20 and 23 are shown in FIG. 2 to emphasize that the devices on which UDM resides can have significant everyday functionality. They are not necessarily dedicated to UDM tasks. In other words, for example, one does not need to go out and purchase a new PDA that is used solely for UDM.

UDM concerns itself with the Application Layers 21 and 24, which comprises the UI 21 and agent 24, and the underlying Wireless Communication Infrastructure 22 and 25, which supports and enables the Application Layers 21 and 24.

The UI will run on virtually any device equipped with adequate processing power and the basic mechanisms for entering commands and displaying results. While FIG. 2 shows the UI 21 and Agent 24 running on separate devices, this is not a requirement. The UI 21 and Agent 24 may co-reside on the same device. Hence the UI 21 may be used to manage the device (e.g., PDA or handset) on which it is running. That is, it may be used to manage itself right along with remote devices.

1. Wireless Communication Infrastructure

One embodiment of UDM's wireless communication infrastructure is built on Bluetooth technology. Bluetooth is a specification developed by a consortium of computing and telecommunications companies (Bluetooth SIG) that defines how devices such as laptops, mobile phones, pagers, and PDA's can communicate via a short-range wireless connection. Bluetooth systems reside on dedicated chipsets and operate in the unlicensed Industrial, Scientific, and Medical (ISM) band at 2.4 GHz.

Bluetooth (or a similar non-line-of-sight wireless communication method) handles the automatic discovery of devices, session control, security/encryption, and other aspects of wireless data transport. Device information captured by Bluetooth or similar protocol bubbles up to the co-resident UDM software, which becomes automatically aware of new devices as they come within close range (10 to 100 meters with Bluetooth) radio range. While Bluetooth or a similar protocol handles the mechanics of wireless communication, UDM handles the mechanics of managing the devices. That is, UDM is responsible for automatically determining the capabilities of a controlled device and for enabling the user to configure those capabilities.

Further, UDM is responsible for determining and communicating to the user the current operational state of the device and for initiating and interpreting diagnostics that are supported by the device. In short, UDM provides the application layer 21 and 24 and Bluetooth provides the wireless infrastructure 22 and 25 on which the application layer 21 and 24 depends.

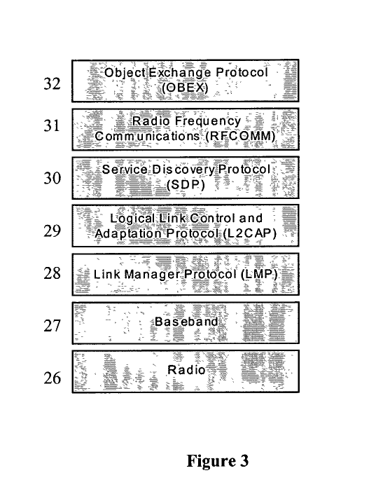

As and example of a high-level view of the wireless infrastructure 22 and 25 in FIG. 2, Bluetooth infrastructure is described below and in FIG. 3.

a) Radio

The Radio layer 26 is the base level of the Bluetooth protocol stack and is responsible for all physical aspects of radio transmission. This includes frequency and frequency hopping, modulation, and power management.

b) Baseband

The Baseband layer 27 specifies Bluetooth networks, synchronous connection-oriented (SCO) and asynchronous connection-less (ACL) physical links, physical and logical channels, data transmission and receipt routines, packet formats, and addressing. Also included are error detection and correction, and basic security.

c) Link Manager Protocol (LMP)

The Link Manager Protocol 28 handles administrative functions relating link setup, security, and control.

d) Logical Link Control and Adaptation Protocol (L2CAP)

The Logical Line Control and Adaptation Protocol 29 defines a wide range of services for both SCO and ACL links including packet segmentation and reassembly, events, signaling, and QOS.

e) Service Discovery Protocol (SDP)

The Service Discovery Protocol 30 provides Bluetooth clients with locations and descriptions of services available to them via Bluetooth servers by using a prescribed set of universal service attribute definitions.

f) Radio Frequency Communications (RFCOMM)

The Radio Frequency Communications 31 protocol is used to emulate serial port interfaces in a wireless environment and is central to the implementation of Bluetooth's cable replacement capability.

g) Object Exchange Protocol (OBEX)

The Object Exchange Protocol (OBEX) 32 is an HTTP-like session-level protocol for the exchange of objects between portable devices. Its standardized objects and associated application framework ensure interoperability among applications. Standardization is achieved through the models it provides to define common objects and operations. Popular implementations of OBEX include the vCard and vCalendar objects, which can be exchanged by Palm handhelds. While originally developed by the Infrared Data Association for infrared devices, OBEX has become one of several existing protocols adopted by Bluetooth.

One embodiment of UDM draws selectively on the OBEX specification. That embodiment of UDM utilizes the OBEX session protocol and subsets of the application framework relating to the mechanics of establishing connections and transferring files between devices. On the other hand, the capabilities and semantics of the objects contained within the exchanged files are proprietary to UDM.

2. The UDM Application Layer

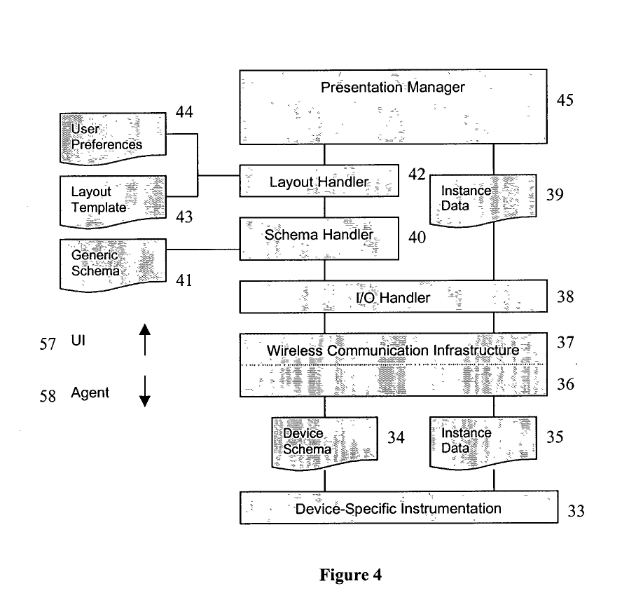

A block diagram of the application layer is presented in FIG. 4 and discussed below.

a) Schema

One of the most important and salient characteristics of UDM UI 57 is its open architecture; that is its ability to support arbitrary new devices without re-compilation. The UI does not require any advance information about a device in order to manage it. This is because all that the UI 57 needs to know about a device 58 is externalized in the form of XML Schema files 41, which are transferred to it at run time by device-resident agents. The schema files describe in generic, structural terms the manageable objects associated with the device.

Information contained by the schema includes:

Names of all configurable elements.

Data type for each element; e.g., string.

Range of legal values on all configurable elements; e.g., minLength, maxLength, pattern specification.

Default values for configurable elements; e.g., “ON”

Documentation that describes the meaning of each data element that can be converted to help text and made available through the UI.

Application information about restrictions on whether element values are editable and/or visible to users.

It is important to point out that the schema are static in nature. They define the structure of the data that describes the device. As used in UDM, schema 41 are akin to class definitions in OOD terminology. Schemas contain data about device data, making schemas forms of metadata. Other components of the UDM architecture such as the Schema Handler 40 and Layout Handler 42 are responsible for reading and interpreting the schema 41. These components apply rules to the metadata that governs how the actual data from the device will be displayed and manipulated by users.

UDM distinguishes between two types of schema: (1) generic schema that should be used by all device vendors and (2) device-specific schemas that are tailor made by vendors to describe specific details about their devices. Each type is discussed below.

(1) Generic Schema

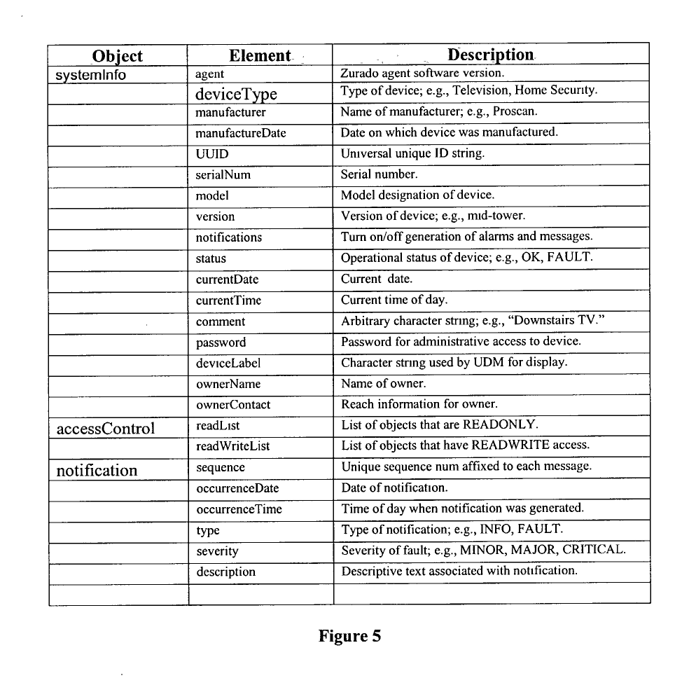

These objects are generic across all supported devices. All UDM devices are expected to maintain and report the generic object. Generic objects form the basis for all group-level operations. Sample generic objects, associated elements, and descriptions are given in FIG. 5.

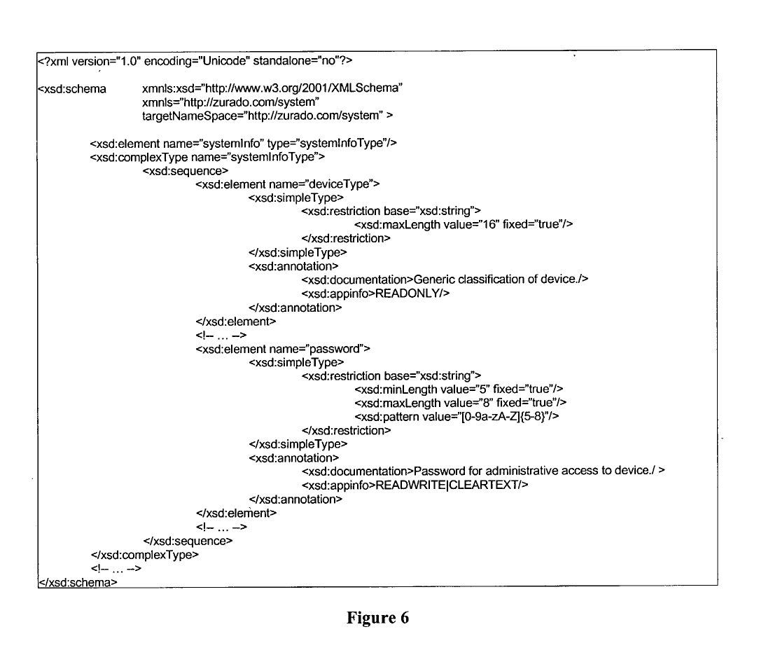

The data contained in the table in FIG. 5 can be encoded in an XML schema document. A fragment of an actual document (in preliminary form) is given below for illustrative purposes in FIG. 6.

(2) Device-Specific Schema

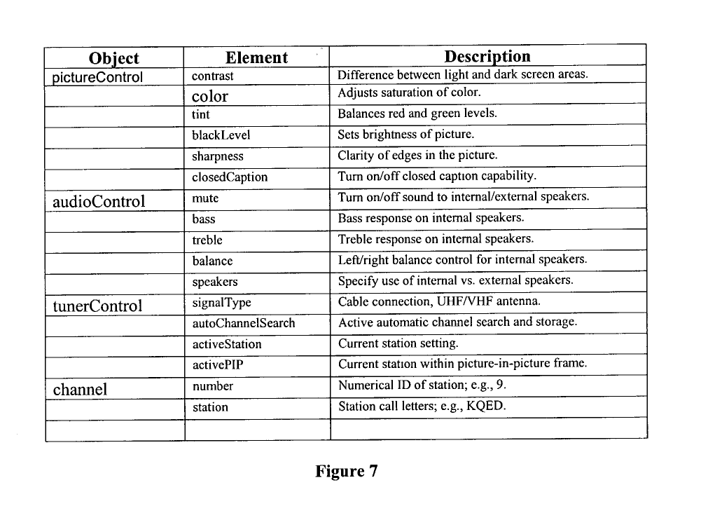

Each device vendor produces schema that describes its devices, and models its behavior to some extent. The table in FIG. 7 shows a subset of objects and related elements associated with an ordinary television. A television was chosen as the device for this example because of its general familiarity and because this example helps to illustrate fundamental differences between UDM and Universal Remote Control.

All objects identified earlier in the table in FIG. 1 could be modeled in this way; the television is merely an example.

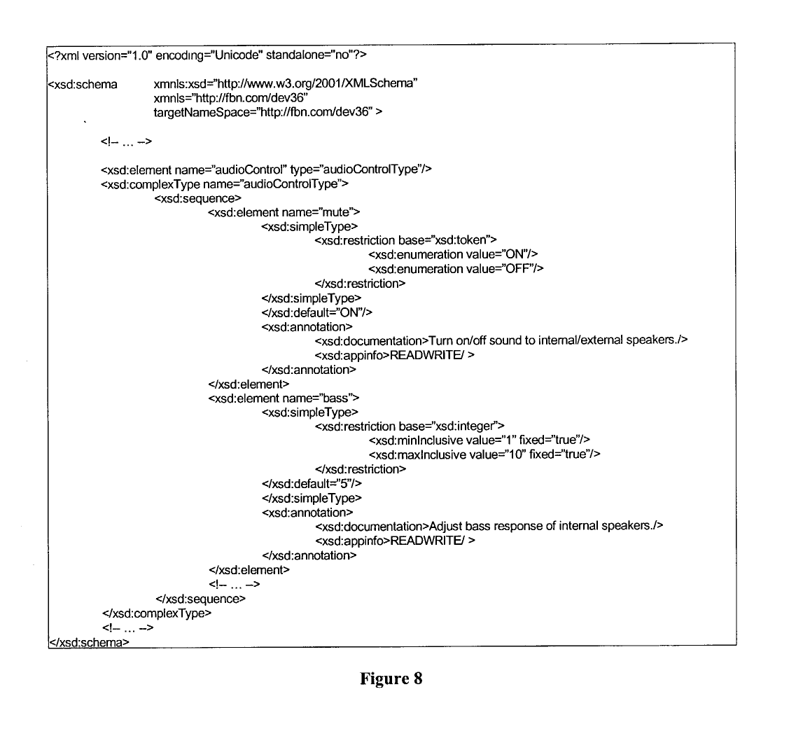

The FIG. 8 shows a fragment from an XML schema file that would be used to encode the information in the table in FIG. 7.

b) Instance Data

Instance data 39 is the actual live data that matches the data structure defined in the schemas. Again, the schemas define the structure of the data and the instance data defines the actual values of the data. The UI and Agent communicate through a continual exchange of instance data. The instance data is packaged into files and transferred to remote devices by way of the I/O Handler 38.

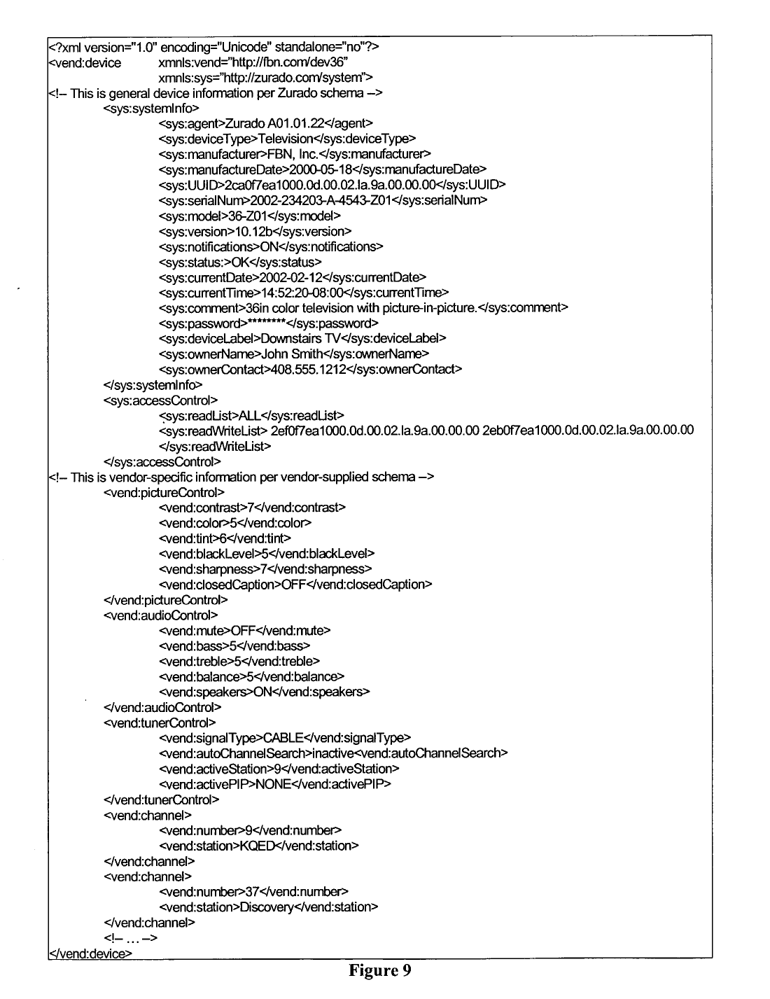

FIG. 9 below shows instance data from the sample television that conforms to the Generic and Device-Specific schemas that were discussed earlier.

This instance data 39 contains instantiated systemInfo and accessControl objects from the generic schema, as well as objects from its own schema. This illustrates the general model that is to be followed. All vendors will include the generic objects in their instance data. In the example above, the hypothetical vendor FBN adds to the Zurado generic objects its own pictureControl, audioControl, tunerControl, and channel objects that pertain specifically to its television device.

c) I/O Handler

The I/O handler 38 serves as the primary interface between the Application Layer 21 and the Wireless Communication Interface 22 via OBEX. This handler module is responsible for the exchange of the XML schema and instance files between the UI 57 and agents 58. It passes into and extracts from OBEX all UDM-related XML files. The I/O Handler 38 is responsible for XML parsing and validation, thereby ensuring that all inbound/outbound XML communications are well-formed.

This module is also responsible for keeping track of active sessions with UDM Agents, and for notifying upper layers when sessions are initiated and terminated.

d) Schema Handler

The Schema Handler module 40 manages XML namespaces, extracts information from schema 41, and sets up appropriate internal structures to store and manipulate the corresponding instance data 39. It also automatically generates data validation routines that are based on data type information, supplied defaults, and prescribed ranges and constraints expressed through XML facets (e.g., minExclusive, maxinclusive, minLength, totalDigits, enumeration, pattern, etc.) These validation routines are called by the Layout Handler 42 and the Presentation Manager 45.

e) Layout Template

The Layout Template 43 is an XML file that maps XML simple data types (e.g., string, token, name, integer, float, dateTime, etc.) and UDM generic types to specific GUI controls (e.g., text field, tree view, spin box, list view, etc.) In addition to support for built-in data types, the template 43 also has semantics for specifying higher-level layout information such as how element containment (i.e., elements containing other elements), multiplicity, and element grouping are to be visualized.

f) User Preferences

By setting User Preferences 44, the end-user will have some latitude in overriding the Layout Template 43. This will enable end-users to customize the look-and-feel of the UI 57 to suit their individual preferences. Users will be able to customize labels, fonts, icons, and other decorations.

More significantly, users will also be able to create and name persistent folders for containing logical groupings of objects; for example, all objects of a particular type such as household appliances or home theater components. Subsequently, users can perform group-level operations on these folders.

g) Layout Handler

The Layout Handler component 42 is responsible for generating the screens based on inputs from the Schema Handler 40 and specifications from the Layout Template 43, and possibly additional input from the User Preferences 44. In addition to generating the appropriate GUI components and proper layout, the Layout Handler 42 is responsible for adjusting where necessary the overall look-and-feel to suit the OS and hardware platform on which it is running.

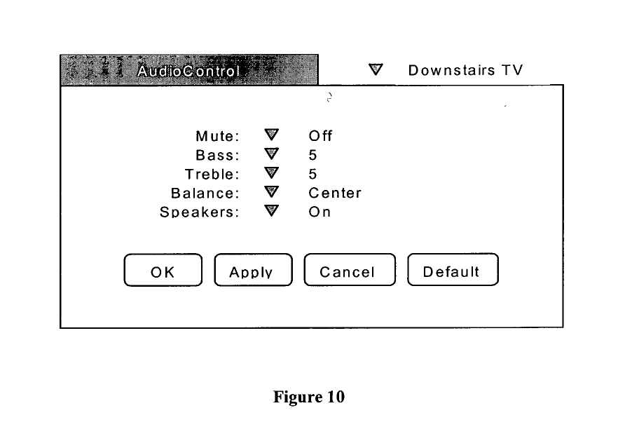

FIG. 10 shows a sample screen for setting audio parameters associated with a television. The screen could be built from the schema and instance files shown in previous examples. Screens like these will be generated on the fly from the schema files, instance data, and the application of formatting rules within the Layout Handler 42. The screens are not hard coded.

UDM had no a priori information about the television. It does not know what a television is or what audio control is all about. Still it produces a UI that is simple to understand and easy to use. It can do this because it has general knowledge about how to layout controls on a screen and everything specific it needs to know about the device is communicated to it—by the device itself via schema and instance data.

It is important to emphasize that the layout and other look-and-feel details are determined by the UDM UI, not by the markup contained in the vendor-generated XML device schema and XML instance data. XML is used for metadata and as a data format, not for data presentation. The UI must maintain layout control in order to ensure UI consistency; that is, universality of the UI across a broad spectrum of supported devices.

h) Presentation Manager

The Presentation Manager 45 arranges all UDM screens on the display, interfaces with native OS window managers and application launchers, and handles all interaction with the user. It validates user input through callbacks to validation routines generated by the Schema Handler 40.

The Presentation Manager 45 converts validated user input into Instance Data 39, which is passed to the I/O Handler 38 and transmitted across the Wireless Communication Infrastructure 37 to remote Agents 58 for processing at the device level.

This module is also responsible for the display and management of user-defined device groupings. This includes support for group-level operations (for example, set time of day on all devices) and for data scoping and filtering capabilities. Group-level operations, scoping, and filtering are run against system data (see Generic Schema section), which is common to all UDM managed devices.

i) Device-Specific Instrumentation

Device-Specific Instrumentation is the device-specific code that acts upon instance data that is passed from the UI 57 to the Agent 58 via XML. For example, if the audioControl->mute element 48 is changed by the UI from ON to OFF, device-specific logic must be written to turn off the mute programmatically once the changed element is received by the Agent. This code is actually developed by the vendor, but will likely involve a UDM development toolkit as described below.

C. Product Packaging

UDM capabilities are delivered in three packages: UI, Agent, and Agent Toolkit. Recall that the UI software is the piece that will be visible to the end user. This contains the device-independent user interface for controlling all managed devices—the essence of UDM. By contrast, the Agent and Agent Toolkit packages will be visible to device vendors. This section briefly summarizes the packaging of each UDM component.

1. UI

The UDM Client software can be packaged in one of two ways: as a pre-packaged utility delivered with UDM-capable devices and made of available to the device users out of the box, or as an add-on, purchased separately and delivered on an expansion card.

As a pre-packaged utility, it could be included in the standard distributions of mainstay handheld operating systems, such as Palm OS and Windows CE and potentially embedded Linux. It could also be made available to frontrunner desktop operating systems such as Windows (95, 98, ME, NT, XP), Solaris, and Linux.

Common expansion cards include Compact Flash (CF), a standards-based architecture and form factor for expansion cards that is used in many Palm OS and Windows CE devices; PCMCIA, another standard typically used in laptops; as well as Sony's MemoryStick and Handspring's Springboard modules.

2. Agent

The UDM Agent 58 software can be made available, in binary form, to vendors of Bluetooth-enabled devices (or those enabled with similar wireless technologies.

The agent software 58 can be bundled with the devices on which it is expected to run. End-users of the device then would not need to load additional firmware, or to be aware of its existence. Each agent instance would be node locked to the device.

The exact physical configuration of the agent 58 will vary depending on the device. Generally it resides in the device's ROM or NVRAM. In another embodiment, the agent can be bundled directly with Bluetooth or similar technology chipsets.

3. Agent Toolkit

The UDM Agent Toolkit comprises the software tools that allow device vendors to build in the software instrumentation required to support UDM. The schemas and instance data constitute the primary vehicle for exchanging information between the UDM UI and Agent devices. Thus the toolkit will consist mainly of API's for creating, deleting, reading, and writing XML schemas and instance data.

Additional utilities are included to support backup and restoration of persistent configuration data and to facilitate RTOS integration.

Modifications and variations can be made to the above disclosed embodiments without departing from the subject and spirit of the invention as defined by the following claims.

What is claimed is:

1. A method for monitoring devices, the method comprising:
a. connecting one or more device servers to a display client;
b. the display client requesting transmission from each of the device servers of device-specific data;
c. the device servers transmitting the requested information to the display client;
d. the display client receiving the device-specific data;
e. the display client translating the device-specific data into a device-independent user interface; and
f. displaying of the received data on the display client using the device-independent user interface.

2. A method for monitoring and controlling devices, the method comprising:
a. connecting one or more device servers to a display client;
b. the display client requesting transmission from each of the device servers of device-specific data;
c. the device servers transmitting the requested information to the display client;
d. the display client receiving the device-specific data;
e. the display client generating a device-independent user interface using the device-specific data;
f. displaying the device-specific data on the display client using the generated device-independent user interface;
g. accepting user input resulting from the user interacting with the user interface displayed on the display client; and
h. controlling the device by sending the commands from the display client to the device that were selected by the user's interaction.

3. A method for monitoring and controlling devices, the method comprising:
a. discovering one or more devices automatically by a display client when the client moves into the range of the device;
b. establishing a connection session between the display client and the detected device;
c. conveying information from the device to the display client regarding the state and capabilities of the device;
d. generating by the display client of a device-independent user interface to display the device information;
e. displaying the device-independent user interface on the display client;
f. controlling the device by the user selecting an option from the device-independent user interface on the display client;
g. sending a command to the device based on the user's selection from the device-independent user interface on the display client; and
h. terminating the session when the display client moves out of the range of the device.

4. A system for monitoring and controlling devices, the system comprising:
a. means for discovering one or more devices automatically by a display client when the client moves into the range of the device;
b. means for establishing a connection session between the display client and the detected device;
c. means for conveying information from the device to the display client regarding the state and capabilities of the device;
d. means for generating by the display client of a device-independent user interface to display the device information;
e. means for displaying the device-independent user interface on the display client;
f. means for controlling the device by the user selecting an option from the device-independent user interface on the display client
g. means for sending a command to the device based on the user's selection from the device-independent user interface on the display client; and
h. means for terminating the session when the display client moves out of the range of the device.

5. A method for monitoring devices, the method comprising:
a. connecting a display client to a communication network;
b. connecting a one or more device servers to the communication network;
c. the display client requesting transmission from each of the device servers of device-specific data;
d. the device servers transmitting the requested information to the display client;
e. the display client receiving the device-specific data;
f. the display client generating a device-independent user interface using the device-specific data; and
g. displaying of the received data on the display client using the device-independent user interface.

6. A method for monitoring and controlling devices, the method comprising:
a. connecting a display client to a communication network;
b. connecting one or more device servers to the communication network;
c. the display client requesting transmission from each of the device servers of device-specific data;
d. the device servers transmitting the requested information to the display client;
e. the display client receiving the device-specific data;
f. the display client translating the device-specific data into a device-independent user interface;
g. displaying the received data on the display client using the device-independent user interface;
h. accepting user input resulting from the user interacting with the device-independent user interface displayed on the display client; and
i. controlling the device by sending the selected commands from the display client to the device.

7. A system for monitoring and controlling devices, the system comprising:
a. means for connecting a display client to a communication network;
b. means for connecting one or more device servers to the communication network;
c. means for the display client requesting transmission from each of the device servers of device-specific data;
d. means for the device servers transmitting the requested information to the display client;
e. means for the display client receiving the device-specific data;
f. means for the display client translating the device-specific data into a device-independent user interface;
g. means for displaying the received data on the display client using the device-independent user interface layout;
h. means for accepting user input resulting from the user interacting with the device-independent user interface displayed on the display client; and
i. means for controlling the device by sending the selected commands from the display client to the device.

8. The method of claim 2, 3, or 6, further comprising:
a. transmitting to the display client by the device servers of control information on operations that the devices have in common;
b. displaying of the in-common operations on the display client in the device-independent user interface;
c. accepting user input resulting from user interaction with the device-independent user interface on the display client; and
d. controlling multiple servers by simultaneously sending in-common commands to multiple servers at once.

9. The system of claim 4 or 7, further comprising:
a. means for transmitting to the display client by the device servers of control information on operations that the devices have in common;
b. means for displaying of the in-common operations on the display client in the device-independent user interface;
c. means for accepting user input resulting from user interaction with the device-independent user interface on the display client; and
d. means for controlling multiple servers by simultaneously sending in-common commands to multiple servers at once.

10. The method of claim 1, 2, 3, 5, or 6, further comprising:
a. requesting by the display client on an automatic and continually repeated basis information from the device server regarding the performance of the device;
b. sending of the performance information by the device server to the display client; and
c. displaying the received information on the display client in the device-independent user interface.

11. The system of claim 4 or 7, further comprising:
a. means for requesting by the display client on an automatic and continually repeated basis information from the device server regarding the performance of the device;
b. means for sending of the performance information by the device server to the display client; and
c. means for displaying the received information on the display client in the device-independent user interface.

12. The method of claim 1, 2, 3, 5, or 6, further comprising:
a. requesting by the display client on an automatic and continually repeated basis information from the device server regarding the environment surrounding the device;
b. sending of the environmental information by the device server to the display client; and
c. displaying the received information on the display client in the device-independent user interface.

13. The system of claim 5 or 7, further comprising:
a. means for requesting by the display client on an automatic and continually repeated basis information from the device server regarding the environment surrounding the device;
b. means for sending of the environmental information by the device server to the display client; and
c. means for displaying the received information on the display client in the device-independent user interface.

14. The method of claim 12, further comprising:
a. displaying by the display client as part of the device-independent user interface of alarms when information received from the device is outside configured performance ranges.

15. The system of claim 13, further comprising:
a. means for displaying by the display client as part of the device-independent user interface of alarms when information received from the device is outside configured performance ranges.

16. The method of claim 14, further comprising:
a. displaying by the display client as part of the device-independent user interface of alarms when received information on environmental parameters is outside configured ranges.

17. The system of claim 15, further comprising:
a. means for displaying by the display client as part of the device-independent user interface of alarms when received information on environmental parameters is outside configured ranges.

18. The method of claim 1, 2, 3, 5, or 6, further comprising:
a. entering into each device server of a list of the identifications of display clients that are authorized to receive from the individual device server;
b. protecting access to the list of the authorized display clients by an encrypted password;
c. requesting by each device server upon connection to each display client of the display client's identification; and
d. terminating by the device server of the connection between it and the display client if that display client's identification is not on the list of authorized display clients.

19. The system of claim 4 or 7, further comprising:
a. means for entering into each device server of a list of the identifications of display clients that are authorized to receive information from the individual device server;
b. means for protecting access to the list of the authorized display clients by an encrypted password;
c. means for requesting by each device server upon connection to each display client of the display client's identification; and
d. means for terminating by the device server of the connection between it and the display client if that display client's identification is not on the list of authorized display clients.

20. The method of claim 18, further comprising:
a. entering in the entry for each display device contained in the authorization lists on each device server a designation whether the particular display device has read only or both read and write permission;
b. checking by each device server upon access by a display client whether the display client is authorized for read only or both read and write access; and
c. allowing the modification of data on the device server by the display client only if the corresponding entry on the authorization list for that display client allows both read and write access.

21. The method of claim 19, further comprising:
a. means for entering in the entry for each display device contained in the authorization lists on each device server a designation whether the particular display device has read only or both read and write permission;
b. means for checking by each device server upon access by a display client whether the display client is authorized for read only or both read and write access; and
c. means for allowing the modification of data on the device server by the display client only if the corresponding entry on the authorization list for that display client allows both read and write access.

22. The method of claim 1, 2, 3, 5, or 6, wherein connecting includes connecting using a point-to-point communication protocol.

23. The method of claim 1, 2, 3, 5, or 6, wherein connecting includes connecting the display client to the device servers using a wireless connection.

24. The method of claim 23, wherein the detection range of the device is about ten meters.

25. The method of claim 23, wherein the detection range of the device is less than ten meters.

26. The method of claim 23, wherein the detection range of the device is less than twenty meters.

27. The method of claim 23, wherein the detection range of the device is less than thirty 10 meters.

28. The method of claim 23, wherein the detection range of the device is more than ten meters.

29. The method of claim 23, wherein connecting includes connecting the display client to one or more of the device servers using Bluetooth protocols.

30. The method of claim 1, 2, 3, 5, or 6, wherein connecting includes connecting the display client to the device servers using a wire connection.

31. The method of claim 1, 2, 3, 5, or 6, wherein the display client runs on a handheld.

32. The method of claim 2, 3, or 6, wherein the device-specific data includes a schema including the names of all configurable elements, and for each configurable element its data type, range, default values, documentation, and security information.

33. The method of claim 2, 3, or 6, wherein the generating of the display includes on-the-fly mapping of data types to user interface components for data manipulation.

34. The method of claim 33, wherein the mapping includes using layout templates for data manipulation and containing semantics for element containment, multiplicity, and grouping.
